(19) United States
(12) Patent Application Publication
(10) Pub. No.: US 2008/0096160 A1
(43) Pub. Date: Apr. 24, 2008

(54) Apparatus for testing dental occlusion of a person under test using two occlusion force sensors

(75) Inventors: Chun-Cheng Hung, Kaohsiung (TW); Douglas Huang, Taipei (TW)

Correspondence Address: PILLSBURY WINTHROP SHAW PITTMAN, LLP, P.O. BOX 10500, MCLEAN, VA, 22102, US

(73) Assignee: KAOHSIUNG MEDICAL UNIVERSITY, Kaohsiung (TW)

(21) Appl. No.: 11/546,990

(22) Filed: Oct. 13, 2006

(30) Foreign Application Priority Data
Aug. 3, 2006 (TW) 095128476

(51) Int. Cl. A61C 19/05

(52) U.S. Cl. 433/68

(57) ABSTRACT

An apparatus for testing dental occlusion of a person under test includes a dental occlusion sensing unit that includes two occlusion force sensors mounted fixedly and respectively to two mounting ends of a connecting tube and operable to sense an occlusion force applied on each of top and bottom faces thereof so as to output an electrical signal corresponding to the occlusion force sensed thereby, and two transmission lines connected electrically to the occlusion force sensors and a processing unit and extending through the connecting tube for transmitting the electrical signals from the occlusion force sensors to the processing unit. The processing unit is operable to generate occlusion force information in relation to the electrical signals from the occlusion force sensors and to be displayed on a display unit.

### BACKGROUND OF THE INVENTION

1. Field of the Invention

The invention relates to an apparatus for testing dental occlusion of a person under test.

2. Description of the Related Art

Dental occlusion diagnosis is generally used to evaluate oral health condition. In particular, after dental filling or orthodontics, malocclusion may result in temporomandibular joint syndrome, temporomandibular disorder, etc.

In a conventional dental occlusion tester, a resistance strain gauge is used to sense an occlusion force of a person under test in a known art. However, the conventional dental occlusion tester can test dental occlusion upon teeth in only one lateral side of an oral cavity of the person under test at one time. As such, it is difficult to judge whether occlusion forces separately sensed by the resistance strain gauge are equivalent. Furthermore, the conventional dental occlusion tester can merely show simple dental occlusion information, such as a final occlusion force. It is desirable that detailed and advanced dental occlusion information can be obtained.

### SUMMARY OF THE INVENTION

Therefore, the object of the present invention is to provide an apparatus for testing dental occlusion of a person under test that can overcome the aforesaid drawbacks of the prior art.

According to one aspect of the present invention, a dental occlusion sensing unit comprises:

a connecting tube having opposite first and second tube portions each having a coupling end, and a mounting end opposite to the coupling end, and a third tube portion having an end connected to the coupling ends of the first and second tube portions;

a pair of occlusion force sensors, each of which is mounted fixedly on the mounting end of a respective one of the first and second tube portions of the connecting tube and has parallel top and bottom faces, each of the occlusion force sensors being operable to sense an occlusion force of a person under test applied on each of the top and bottom faces so as to output an electrical signal corresponding to the occlusion force sensed thereby; and

a pair of transmission lines connected electrically and respectively to the occlusion force sensors and extending respectively through an assembly of the first and third tube portions of the connecting tube and an assembly of the second and third tube portions of the connecting tube for transmitting the electrical signals from the occlusion force sensors.

According to another aspect of the present invention, there is provided an apparatus for testing dental occlusion of a person under test. The apparatus comprises:

a dental occlusion sensing unit including
a connecting tube having opposite first and second tube portions each having a coupling end, and a mounting end opposite to the coupling end, and a third tube portion having an end connected to the coupling ends of the first and second tube portions,
a pair of occlusion force sensors, each of which is mounted fixedly on the mounting end of a respective one of the first and second tube portions of the connecting tube and has parallel top and bottom faces, each of the occlusion force sensors being operable to sense an occlusion force of the person under test applied on each of the top and bottom faces so as to output an electrical signal corresponding to the occlusion force sensed thereby, and
a pair of transmission lines connected electrically and respectively to the occlusion force sensors and extending respectively through an assembly of the first and third tube portions of the connecting tube and an assembly of the second and third tube portions of the connecting tube for transmitting the electrical signals from the occlusion force sensors;

a processing unit coupled electrically to the transmission lines for receiving the electrical signals transmitted thereby, the processing unit being operable to generate occlusion force information in relation to the electrical signals from the occlusion force sensors; and

a display unit connected electrically to the processing unit for displaying the occlusion force information from the processing unit thereon.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view showing the preferred embodiment of an apparatus for testing dental occlusion of a person under test according to the present invention; and

FIG. 2 is a schematic view showing a dental occlusion sensing unit of the preferred embodiment when in a state of use.

### DETAILED DESCRIPTION OF THE PREFERRED EMBODIMENT

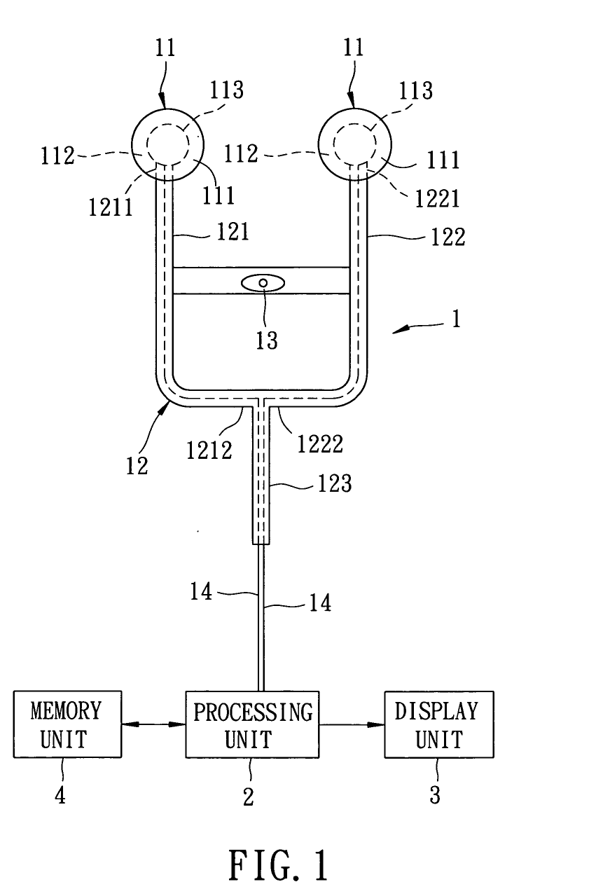

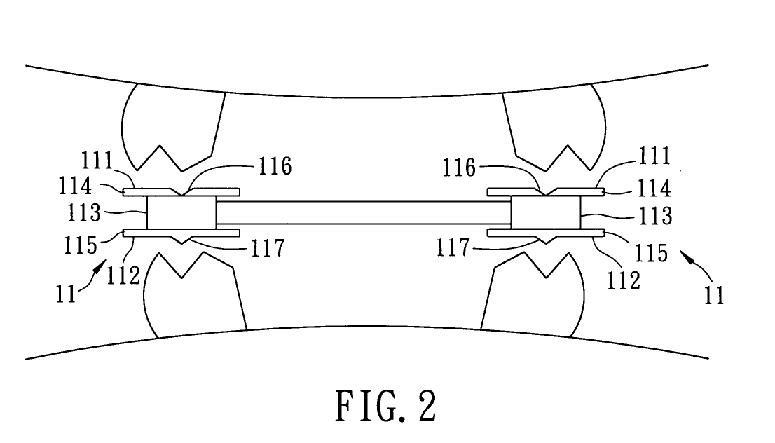

Referring to FIGS. 1 and 2, the preferred embodiment of an apparatus for testing dental occlusion of a person under test according to the present invention is shown to include a dental occlusion sensing unit 1, a processing unit 2, a display unit 3, and a memory unit 4.

The dental occlusion sensing unit 1 includes a connecting tube 12, a pair of occlusion force sensors 11, and a pair of transmission lines 14.

The connecting tube 12 has opposite first and second tube portions 121, 122 each having a coupling end 1212, 1222, and a mounting end 1211, 1221 opposite to the coupling end 1212, 1222, and a third tube portion 123 having an end connected to the coupling ends 1212, 1222 of the first and second tube portions 121, 122.

Each occlusion force sensor 11 is mounted fixedly on a respective one of the mounting ends 1211, 1221 of the first and second tube portions 121, 122 of the connecting tube 12, and has parallel top and bottom faces 111, 112. Each occlusion force sensor 11 is operable to sense an occlusion force of the person under test applied on each of the top and bottom faces 111, 112 so as to output an electrical signal corresponding to the occlusion force sensed thereby. In this embodiment, each occlusion force sensor 11 includes circular upper and lower plates 114, 115 spaced apart from each other and configured respectively with the top and bottom faces 111, 112, and a resistance strain device 113, for example, which is composed of four resistance strain gauges (not shown) interconnected in a bridge form, clamped between the upper and lower plates 114, 115. The top face 111 of the upper plate 114 of each occlusion force sensor 11 is formed with a central recess 116, and the bottom face 112 of the lower plate 115 of each occlusion force sensor 11 is formed with a central projection 117 such that the central recesses 116 in the top plates 114 and the central projections 117 on the bottom plates 115 are adapted to engage easily and respectively tooth peaks and valleys of the person under test, thereby enhancing stability during test. Preferably, a level 13 is disposed between the first and second tube portions 121, 122 of the connecting tube 12 for indicating whether the top and bottom faces 111, 112 of the occlusion force sensors 11 are parallel to each other.

The transmission lines 14 are connected electrically and respectively to the occlusion force sensors 11, and extend respectively through an assembly of the first and third tube portions 121, 123 of the connecting tube 12 and an assembly of the second and third tube portions 122, 123 of the connecting tube 12 for transmitting the electrical signals from the occlusion force sensors 11.

The processing unit 2 is coupled electrically to the transmission lines 14 for receiving the electrical signals transmitted thereby. The processing unit 2 is operable to generate occlusion force information in relation to the electrical signals from the occlusion force sensors 11.

The display unit 3 is connected electrically to the processing unit 2 for displaying the occlusion force information from the processing unit 2 thereon.

The memory unit 4 is connected electrically to the processing unit 2 for storing the occlusion force information therein.

It is noted that, in this embodiment, the occlusion force information includes a maximum occlusion force, a minimum occlusion force, an average occlusion force or a sum of occlusion forces during a period.

In sum, due to the presence of the two occlusion force sensors 11, the apparatus for testing dental occlusion of the present invention can simultaneously test dental occlusion upon the teeth in left and right lateral sides of an oral cavity of the person under test. Moreover, the apparatus for testing dental occlusion of the present invention can generate and display relatively detailed occlusion force information as compared to the prior art.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A dental occlusion sensing unit comprising:
a connecting tube having opposite first and second tube portions each having a coupling end, and a mounting end opposite to said coupling end, and a third tube portion having an end connected to said coupling ends of said first and second tube portions;
a pair of occlusion force sensors, each of which is mounted fixedly on said mounting end of a respective one of said first and second tube portions of said connecting tube and has parallel top and bottom faces, each of said occlusion force sensors being operable to sense an occlusion force of a person under test applied on each of said top and bottom faces so as to output an electrical signal corresponding to the occlusion force sensed thereby; and
a pair of transmission lines connected electrically and respectively to said occlusion force sensors and extending respectively through an assembly of said first and third tube portions of said connecting tube and an assembly of said second and third tube portions of said connecting tube for transmitting the electrical signals from said occlusion force sensors.

2. The dental occlusion sensing unit as claimed in claim 1, further comprising a level disposed between said first and second tube portions of said connecting tube for indicating whether said top and bottom faces of said occlusion force sensors are parallel to each other.

3. The dental occlusion sensing unit as claimed in claim 1, wherein each of said occlusion force sensors includes upper and lower plates spaced apart from each other and configured respectively with said top and bottom faces, and a resistance strain device clamped between said upper and lower plates.

4. The dental occlusion sensing unit as claimed in claim 3, wherein said top face of said upper plate of each of said occlusion force sensors is formed with a central recess, said bottom face of said lower plate of each of said occlusion force sensors being formed with a central projection.

5. An apparatus for testing dental occlusion of a person under test, comprising:
a dental occlusion sensing unit including
a connecting tube having opposite first and second tube portions each having a coupling end, and a mounting end opposite to said coupling end, and a third tube portion having an end connected to said coupling ends of said first and second tube portions,
a pair of occlusion force sensors, each of which is mounted fixedly on said mounting end of a respective one of said first and second tube portions of said connecting tube and has parallel top and bottom faces, each of said occlusion force sensors being operable to sense an occlusion force of the person under test applied on each of said top and bottom faces so as to output an electrical signal corresponding to the occlusion force sensed thereby, and
a pair of transmission lines connected electrically and respectively to said occlusion force sensors and extending respectively through an assembly of said first and third tube portions of said connecting tube and an assembly of said second and third tube portions of said connecting tube for transmitting the electrical signals from said occlusion force sensors;
a processing unit coupled electrically to said transmission lines for receiving the electrical signals transmitted thereby, said processing unit being operable to generate occlusion force information in relation to the electrical signals from said occlusion force sensors; and
a display unit connected electrically to said processing unit for displaying the occlusion force information from said processing unit thereon.

6. The apparatus as claimed in claim 5, wherein said dental occlusion sensing unit further includes a level disposed between said first and second tube portions of said connecting tube for indicating whether said top and bottom faces of said occlusion force sensors are parallel to each other.

7. The apparatus as claimed in claim 5, wherein each of said occlusion force sensors of said dental occlusion sensing unit includes upper and lower plates spaced apart from each other and configured respectively with said top and bottom faces, and a resistance strain device clamped between said upper and lower plates.

8. The apparatus as claimed in claim 7, wherein said top face of said upper plate of each of said occlusion force sensors of said dental occlusion sensing unit is formed with a central recess, said bottom face of said lower plate of each of said occlusion force sensors being formed with a central projection.

9. The apparatus as claimed in claim 5, further comprising a memory unit connected electrically to said processing unit for storing the occlusion force information therein.

10. The apparatus as claimed in claim 5, wherein the occlusion force information includes at least one of a maximum occlusion force, a minimum occlusion force, an average occlusion force, and a sum of occlusion forces during a period.
